(19) United States
(12) Patent Application Publication
(10) Pub. No.: US 2018/0236487 A1
(43) Pub. Date: Aug. 23, 2018

(54) LINEAR VIBRATION MOTOR

(71) Applicant: Nidec Copal Corporation, Tokyo (JP)

(72) Inventors: Masaya ENDO, Tokyo (JP); Risa NAKAZATO, Tokyo (JP)

(73) Assignee: Nidec Copal Corporation, Tokyo (JP)

(21) Appl. No.: 15/516,511

(22) PCT Filed: Oct. 5, 2015
(86) PCT No.: PCT/JP2015/078197

§ 371 Date: Apr. 3, 2017

(30) Foreign Application Priority Data
Oct. 7, 2014 (JP) 2014-206787

(51) Int. Cl. B06B 1/04; H02K 33/16; H02K 33/02; H02P 25/032; H02K 5/04

(52) U.S. Cl. CPC B06B 1/045; H02K 33/16; H02K 5/04; H02P 25/032; H02K 33/02

(57) ABSTRACT

A linear vibration motor wherein the amplitude along the direction of thickness is limited, and wherein vibration is produced with a large thrusting force while securing adequate mass in the weight. The linear vibration motor comprises: a coil that is supported over a bottom plate that faces a top face portion of a case, and that is wound along a plane that is perpendicular to the bottom plate; a magnetic pole portion that is able to produce a thrusting force in the vertical direction through an electric current that flows in the coil; a weight that vibrates integrally with the magnetic pole portion; and an elastic member that supports the weight on the top face portion of the case so as to enable vertical vibration.

### CROSS-REFERENCE TO RELATED APPLICATIONS

This is a U.S. national phase application under 35 U.S.C. § 371 of International Patent Application No. PCT/JP2015/078197, filed Oct. 5, 2015, and claims benefit of priority to Japanese Patent Application No. 2014-206787, filed Oct. 7, 2014. The entire contents of these applications are hereby incorporated by reference.

### FIELD OF TECHNOLOGY

The present invention relates to a linear vibration motor.

### BACKGROUND

A vibration motor (or “vibration actuator”) vibrates in accordance with a signal, such as an incoming call in a communication device, an alarm in any of a variety of electronic devices, or the like, to communicate to the user of the electronic device, or the user that touches can operating panel (a display panel) of the electronic device, that a signal has been produced, where such vibration motors are provided in a variety of electronic devices, such as in mobile information terminals.

Among the various forms of vibration motors that are under development, there are known linear vibration motors that are able to generate relatively large vibrations through linear reciprocating vibrations of a movable element. This linear vibration motor is provided with a structure wherein a coil is secured to a frame, and wherein an oscillator that is equipped with a weight on a magnet that produces a driving force (a thrusting force) in the axial direction, in cooperation with the coil, is supported by a magnet so as to enable vibration relative to the frame in the axial direction. In the explanation below, “up,” “down,” and “vertical” indicate the direction toward one side the direction toward the other side, in the direction of the vibration, regardless of the direction of the direction of the ground.

The linear vibration motor must be provided in a thin electronic device, and must apply a vibration effectively in response to a contact with the display panel (a touch panel/display panel), and so itself must be thin and must vibrate effectively along the direction of thickness. There is known prior art, set forth in Japanese Unexamined Patent Application Publication No. 2011-30403, below, as a linear vibration motor that satisfies both of these needs.

This prior art was structured from: a case, having a thin interior space; a stator that is provided with a coil that has a bottom end that is secured to a bracket that forms the bottom face of the case; and an oscillator that is made from a magnet, a yoke, and a weight, supported by a spring on the top face portion of the case, so as to be supported so as to enable vibrations up and down within the interior space of the case, wherein: the magnet is supported so as to enable vibration within a coil that is wound into a cylindrical shape around the direction of vibration, wherein a yoke is disposed encompassing the magnet beyond the top end of the coil, and a cylindrical magnetic gap is formed, corresponding to the coil, between the magnet and the yoke.

### SUMMARY

The thin linear vibration motor according to the prior art has the amplitude thereof limited by the vertical-direction of thickness of the case, and while an effective vibration is to be achieved through increasing the mass of the weight, if the volume of the weight in the interior space, which is constant within the case, is increased, then, given the structure, the diameter of the coil must be reduced, with a structure wherein, at the time of vibration, most of the coil is outside of the magnetic gap, and thus there is a problem in that vibration of the oscillator with a large thrusting force is not possible.

Moreover, the conventional linear vibration motor as described above is structured with the oscillator supported by a spring in a state wherein it is suspended on the top face portion of the case, where only the bottom end of the coil is supported on a bracket, and the yoke is disposed on the top end thereof, and thus the structure is one wherein the center part of the top face portion of the case is not supported. Because of this, extraneous vibrations are produced in the top face portion of the case, and thus there is a problem in that this produces noise.

The present invention is to respond to such problems, and the object thereof is to provide a linear vibration motor wherein the amplitude along the direction of thickness is limited, wherein a vibration can be produced with a large thrusting force while securing an adequate mass for the weight, and able to prevent the occurrence of noise through preventing extraneous vibrations in the top face portion of the case.

In order to achieve such an object, the linear vibration motor of the present invention is equipped with the following structures: a linear vibration motor comprising: a case having a top face portion; a bottom plate that faces the top face portion; a coil that is supported over the bottom plate and that is wound along a plane that is perpendicular to the bottom plate; a magnetic pole portion for producing a thrusting force in the vertical direction through an electric current that flows in the coil; a weight that vibrates together with the magnetic pole portion; and an elastic member for supporting the weight so as to enable vibration in the vertical direction. The linear vibration motor having the distinctive features set forth above enables the provision of a linear vibration motor wherein the amplitude along the direction of thickness is limited, wherein a vibration can be produced with a large thrusting force while securing an adequate mass for the weight. Moreover, this can prevent the occurrence of noise through preventing extraneous vibrations in the top face portion of the case.

### BRIEF DESCRIPTIONS OF THE DRAWINGS

FIG. 1 is a cross-sectional view illustrating an overall structure of a linear vibration motor according to an example according to the present invention.

FIG. 2 is an exploded perspective diagram illustrating the overall structure of a linear vibration motor according to an example according to the present invention.

FIG. 3 is an explanatory diagrams (perspective diagrams) illustrating a coil and a cradle portion, for securing the coil, in a linear vibration motor according to an example according to the present invention, where FIG. 3 (a) shows a state wherein the coil is secured by the cradle portion, and FIG. 3 (b) shows the cradle portion alone.

FIG. 4 is explanatory diagrams illustrating the magnetic pole portions and the coil in a linear vibration motor according to an example according to the present invention (wherein FIG. 4 (a) is a perspective diagram and FIG. 4 (b) is a cross-sectional view).

FIG. 5 is a plan view of a state wherein the case has been removed in a linear vibration motor according to an example according to the present invention.

FIG. 6 is a plan view illustrating the structure on the bottom plate in a linear vibration motor according to an example according to the present invention.

FIG. 7 is an explanatory diagram illustrating an electronic device (a mobile information terminal) in which is provided a linear vibration motor according to an example according to the present invention.

### DETAILED DESCRIPTION

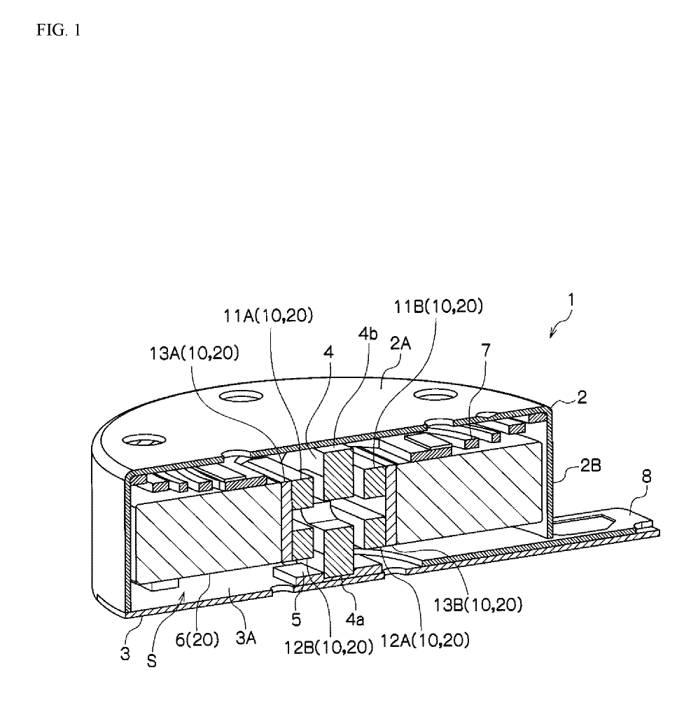

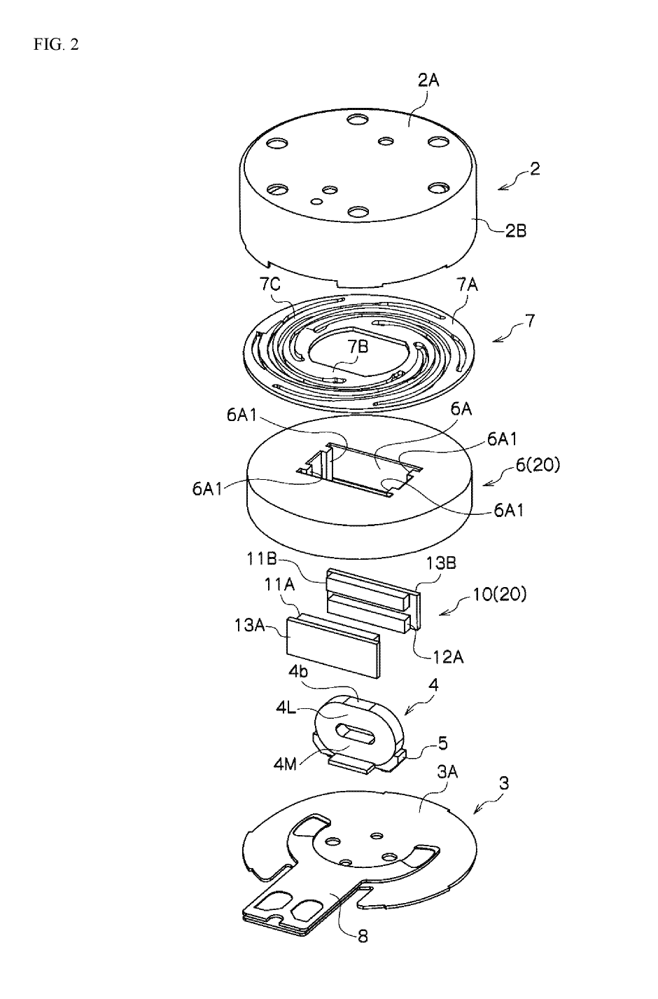

An example according to the present invention will be explained below in reference to the drawings. FIG. 1 (a cross-sectional view) and FIG. 2 (an exploded perspective diagram) illustrate the overall structure of a linear vibration motor according to an example according to the present invention. The linear vibration 1 comprises a case 2, a bottom plate 3, a coil 4, a magnetic pole portion 10, a weight 6, and an elastic member 7, wherein an oscillator 20 is structured from the weight 6 and the magnetic pole portion 10, where the oscillator 20 vibrates up and down within a vibration space S within the case 2.

The case 2 is provided with, at least, a top face portion 2A. In the example in the illustration, the case 2 comprises a top face portion 2A and side face portions 2B that surround the top face portion 2A, having a thin vibration space S on the interior thereof. The bottom plate 3 is provided facing the top face portion 2A, and comprises a flat supporting face 3A for supporting the coil 4. In the example that is illustrated, the top face portion 2A and the bottom plate 3 have essentially circular planar shapes, but if there is no limitation thereto, and instead the top face portion 2A and the bottom plate 3 may be of arbitrary planar shapes, such as rectangles.

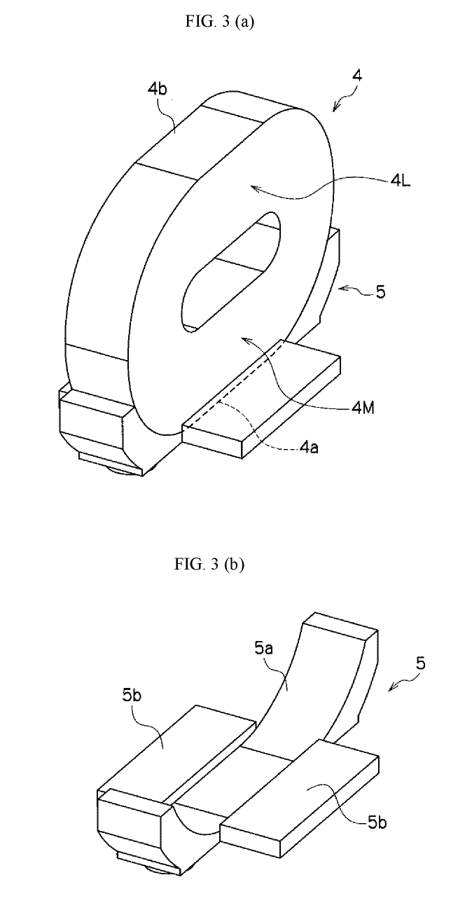

The coil 4 is supported on the bottom plate 3, and is wound along a plane that is perpendicular to the bottom plate 3. Through this, the axial direction of the windings of the coil 4 will be in a direction along the bottom plate 3 and the top face portion 2A. In this coil 4, as illustrated in FIG. 3 (a), the bottom side outer peripheral surface 4a is secured to a cradle portion 5 over the bottom plate 3. The cradle portion 5, as illustrated in FIG. 3 (B), has a supporting face portion 5a for supporting a flat portion and a curved surface portion of the bottom side outer peripheral surface 4a of the coil 4, and also has supporting wall portions 5b for holding, on both the left and right side, the lower side faces of the coil 4, which is standing upright.

The top side outer peripheral surface 4b of the coil 4 can be secured to the top face portion 2A of the case 2. In this case, the height of the coil 4, including the height of the cradle portion 5, is set so as to match the spacing between the top face portion 2A of the case 2 and the supporting face 3A of the bottom plate 3. Securing the top side outer peripheral surface 4b of the coil 4 and the top face portion 2A of the case 2 causes the center portion of the top face portion 2A to be supported, and the coil 4 that is interposed between the top face portion 2A and the supporting face 3A of the bottom plate 3 serves as a supporting column, making enabling the prevention of extraneous vibrations in the top face portion 2A of the case 2, enabling the prevention of noise.

Moreover, the coil 4, which is wound along a plane that is perpendicular to the bottom plate 3 is provided with a top side straight portion 4L and a bottom side straight portion 4M that are essentially parallel along the top face portion 2A or the supporting face 3A of the bottom plate 3. The provision of the top side straight portion 4L and the bottom side straight portion 4M cause the coil 4 to be wound into an oval shape. The top side straight portion 4L and the bottom side straight portion 4M are coil parts wherein electrical currents flow in mutually opposite directions, and the lengths thereof can be set to be long, to enable the oscillator 20 to B vibrated up-in-down with a larger thrusting force, in cooperation with the magnetic pole portions 10, described below. Because here the top side straight portion 4L and the bottom side straight portion 4M can be set to be long, regardless of the thickness, even in the case of producing a thin linear vibration motor 1 wherein the spacing between the top face portion 2A of the case 2 and the supporting face 3A of the bottom plate 3 is narrow, this enables up-and-down vibration of the oscillator 20 with a large thrusting force in a thin linear vibration motor 1.

The weight 6 is disposed within a vibration space S, and has a thickness that is greater than the vertical spacing of the vibration space S, extending out of the vibration space, and has a larger planar shape that can be contained within the vibration space S, thereby making it possible to secure a weight that is adequate to achieve an effective vibration. The material for the weight 6 uses a material that is non-magnetic and that has a high specific gravity, where tungsten, for example, may be used.

The weight 6, which vibrates integrally with the magnetic pole portion 10, is formed with an opening portion 6A, in which the magnetic pole portion 10 is installed and through which the coil 4 passes in the vertical direction. The opening portion 6A is formed essentially rectangularly in the plan view, and is provided with a protruding portion 6A1 for maintaining a state wherein the yolks 13A and 13B of the magnetic pole portion 10, described above, are separated from each other.

The weight 6 is supported on the top face portion 2A of the case 2 by the elastic member 7 so as to enable up-and-down vibration thereof. The elastic member 7 is a leaf spring that has an outer peripheral portion 7A that is secured to the top face portion 2A side, an inner peripheral portion 7B that is secured to the top face of the weight 6, and an elastically deformable portion 7C that is formed between the outer peripheral portion 7A and the inner peripheral portion 7B. The weight 6 is elastically supported by the elastic member 7 in a state wherein the weight 6 is suspended from the top face portion 2A. Note that while, in the example that is illustrated, the weight 6 is supported by the elastic member 7 on the top face portion 2A side, it may instead be supported through an elastic member 7 on the supporting face 3A side of the bottom plate 3. In that case, the outer peripheral portion 7A of the elastic member 7 would be secured to the supporting face 3A, and the inner peripheral portion 7b would be secured to the bottom face of the weight 6.

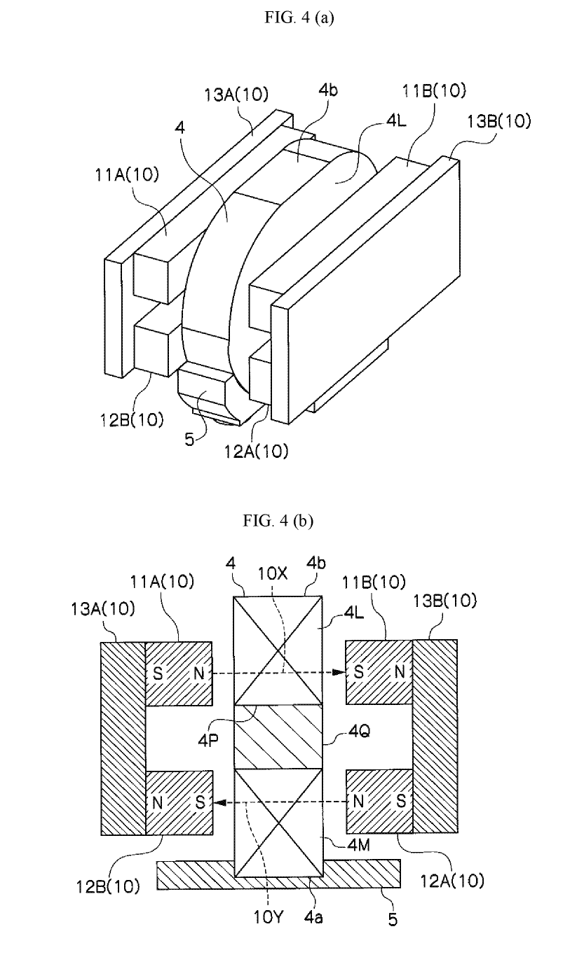

As illustrated in FIGS. 4 (a) and (b), the magnetic pole portion 10 that is installed in the opening portion 6A of the weight 6 comprises a pair of first magnets 11A and 11B, a pair of second magnets 12A and 12B, and a pair of yolks 13A and 13B. The first magnet 11A and second magnet 12B are connected to the yolk 13A, and the first magnet 11B and the second magnet 12A are joined to the yoke 13B.

Additionally, the pair of first magnets 11A and 11B form a magnetic gap with the top side straight portion 4L of the coil 4 held therein, and the pair of second magnets 12A and 12B form a magnetic gap with the bottom side straight portion 4M of the coil 4 held therein. As illustrated in FIG. 4 (b), here a magnetic circuit is structured wherein the directions of the magnetic fluxes are in mutually opposing directions for the first lines of magnetic force 10X that are perpendicular to the top side straight portion 4L of the coil 4 in the magnetic gap between the pair of first magnets 11A and 11B, and the second lines of magnetic force 12Y that are perpendicular to the bottom side straight portion 4M of the coil 4 in that the magnetic gap between the pair of second magnets 12A and 12B. The magnetic pole portion 10, through structuring such a magnetic circuit, enables a thrusting force in the vertical direction through the electric current that flows in the coil 4.

Here thrusting forces that are always in the same direction will act on the top side straight portion 4L and on the bottom side straight portion 4M of the coiled 4, and thus the thrusting force that is produced by the first magnets 11A and 11B and the thrusting force that is produced by the second magnets 12A and 12B will add together, enabling the oscillator 20 to be vibrated with a large thrusting force. Moreover, the coil 4 is disposed so as to be wide between the top face portion 2A of the case 2 and the supporting face 3A of the bottom plate 3, making it possible to reduce extremely the top side straight portion 4L and the bottom side straight portion 4M from coming out of the magnetic gaps of the first magnets 11A and 11B and of the second magnets 12A and 12B, and enabling the oscillator 20 to be vibrated with a large thrusting force thereby.

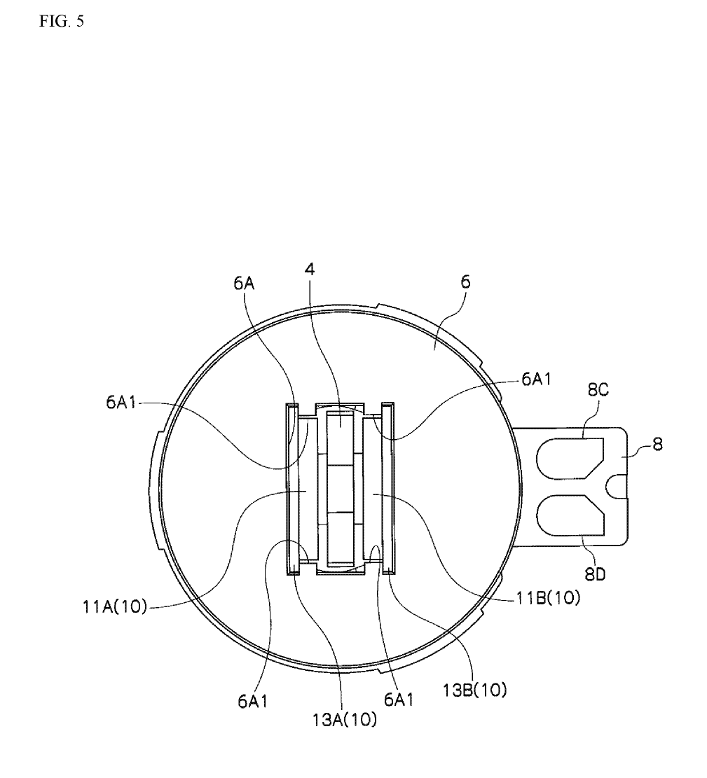

As illustrated in FIG. 5, on one side of the coil 4, one of the first magnet 11A (11B) and one of the second magnets 12B (12A) are connected to the yolk 13A (13B), where the yoke 13A (13B) is held in a groove portion on the outside of the protruding portion 6A1 within the opening portion 6A of the weight 6. The provision of such a protruding portion 6A1 enables the yolks 13A and 13B, which are equipped with the first magnets 11A and 11B and the second magnets 12A and 12B and that attract each other, to be held apart from each other reliably, enabling the step for integrally connecting together the weight 6 and the magnetic pole portions 10 to be carried out more easily.

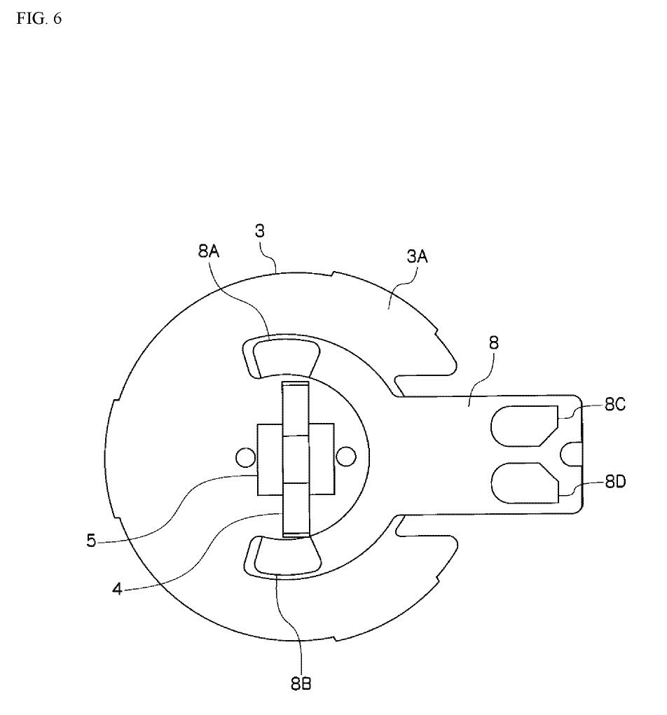

FIG. 6 illustrates the structure on the bottom plate 3. The supporting face 3A of the bottom plate 3 is a flat, and the coil 4 is supported thereon through a cradle portion 5, as described above. A circuit board (FPC) 8, for supplying power to the coil 4, is provided on the supporting face 3A of the bottom plate 3. The circuit board 8 is provided with coil connecting terminals 8A and 8B near to the coil 4, and provided with outside connecting terminals 8C and 8D on the outside of the bottom plate 3. In this way, the bottom plate 3 can be made flat, enabling a reduction in the processing cost for the bottom plate 3, enabling the linear vibration motor 1 to be manufactured inexpensively.

As described above, in the linear vibration motor 1 according to an example according to the present invention, an oscillator 20 that vibrates up-and-down is structured through joining together a weight 6 and a magnetic pole portion 10 that can produce a thrusting force in the vertical direction, through an electric current that flows in the coil 4, where the coil 4 that is wrapped along a plane that is perpendicular to the bottom plate 3 is supported over the bottom plate 3, enabling vibration with a large thrusting force, while securing an adequate weight for the weight 6, in a linear vibration motor wherein the amplitude along the direction of thickness is limited.

Moreover, the coil 4 is interposed between the top face portion 2A of the case 2 and the bottom plate 3, with the bottom side outer peripheral surface 4a of the coiled 4 secured to the bottom plate 3 side and the top side outer peripheral surface 4b of the coil 4 secured to the top face portion 2A side of the case 2, enabling the center portion of the top face portion 2A of the case 2 to be supported by the coil 4, enabling suppression of extraneous vibrations in the top face portion 2A, enabling prevention of noise. At this time, as illustrated in FIG. 4 (b), a core portion 4P of the coil 4 is embedded in a core material 4Q that is made from a nonmagnetic material, such as a resin material, or the like, enabling an improvement in the compressive strength of the coil 4, enabling more stable support of the top face portion 2A of the case 2.

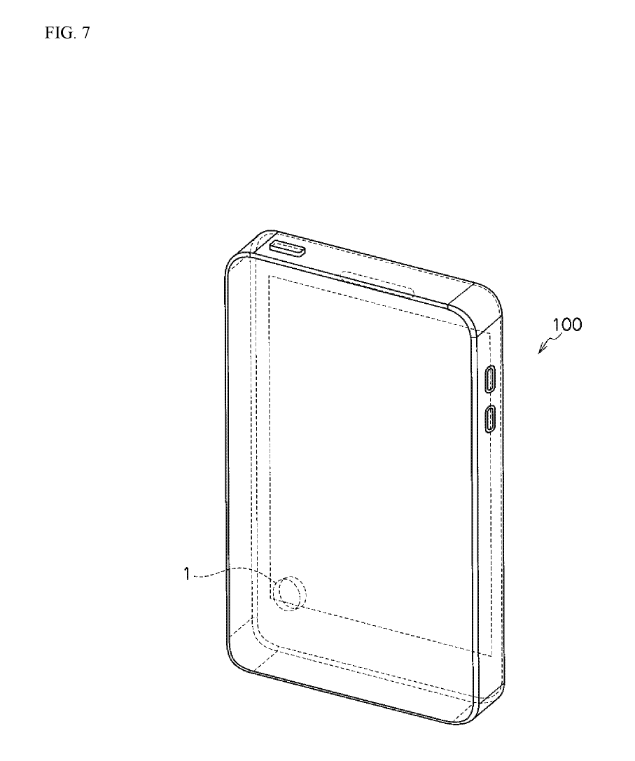

FIG. 7 illustrates a mobile information terminal 100 as an example of an electronic device equipped with a linear vibration motor 1 according to an example according to the present invention. The mobile information terminal 100 that is equipped with the compact linear vibration motor 1 that is thin, enabling a reduction in thickness, and that vibrates effectively along the direction of thickness, can communicate to users, through effective vibrations that tends not to produce noise, incoming calls in a communication function, or the beginning or end of an operation, such as an alarm function. Moreover, in the mobile information terminal 100, the reduced thickness of the linear vibration motor 1 enables superior portability and superior design. The linear vibration motor 1 is able to transmit information through applying a vibration effectively to, for example, the finger of the user when using a touch panel, through the ability to apply an effective vibration along the direction of thickness of a mobile information terminal 100 that itself is of reduced thickness.

While examples according to the present invention were described in detail above, referencing the drawings, the specific structures thereof are not limited to these examples, but rather design variations within a range that does not deviate from the spirit and intent of the present invention are also included in the present invention.

1. A linear vibration motor comprising:
a case having a top face portion;
a bottom plate that faces the top face portion;
a coil supported over the bottom plate and wound along a plane that is perpendicular to the bottom plate;
a magnetic pole element producing a thrusting force in the vertical direction through an electric current that flows in the coil;
a weight that vibrates together with the magnetic pole element; and
an elastic member for supporting the weight so as to enable vibration in the vertical direction.

2. The linear vibration motor as set forth in claim 1, wherein: the bottom side outer peripheral surface of the coil is secured to a cradle portion over the bottom plate.

3. The linear vibration motor as set forth in claim 1, wherein:
the top side outer peripheral surface of the coil is secured to the top face portion of the case.

4. The linear vibration motor as set forth in claim 1, wherein:
the coil is provided with a top side straight portion and a bottom side straight portion that are essentially parallel, along the top face portion; and
the magnetic pole element comprises:
a pair of first magnets, having the top side straight portion therebetween, and having first lines of magnetic force that are perpendicular to the top side straight portion;
a pair of second magnets, having the bottom side straight portion therebetween, and having second lines of magnetic force in a direction opposite from the first lines of magnetic force, perpendicular to the bottom side straight portion; and
yolks to which the first magnets and the second magnets are connected on both sides of the coil.

5. The linear vibration motor as set forth in claim 1, wherein:
the bottom plate has a flat supporting face; and a circuit board for supplying power to the coil is provided on the supporting face.

6. The linear vibration motor as set forth in claim 1, wherein:
the case has a top face portion of a round shape, and a side face portion that encompasses the top face portion, and, on the inside of the top face portion and the side face portion, has a thin vibration space wherein the weight vibrates.

7. A mobile information terminal comprising a linear vibration motor as set forth in claim 1.
